(19) United States
(12) Patent Application Publication
(10) Pub. No.: US 2015/0012819 A1
(43) Pub. Date: Jan. 8, 2015

(54) TEMPLATE-DRIVEN DECORATION ENGINE

(71) Applicant: LinkedIn Corporation, Mountain View, CA (US)

(72) Inventors: Veena Basavaraj, Sunnyvale, CA (US); Eran Leshem, Mountain View, CA (US); Brian J. Geffon, Mountain View, CA (US)

(73) Assignee: LinkedIn Corporation, Mountain View, CA (US)

(21) Appl. No.: 13/953,627

(22) Filed: Jul. 29, 2013

Related U.S. Application Data
(60) Provisional application No. 61/842,236, filed on Jul. 2, 2013.

(51) Int. Cl. G06F 17/22

(52) U.S. Cl. CPC G06F 17/2247
USPC 715/236

(57) ABSTRACT

A system, apparatus and method are provided for dynamically generating decorated data for presenting a web page, at the time of rendering the web page. A request for the web page is received at a front-end server, and a template for generating the page's markup language is retrieved (e.g., a template generated using the Dust templating language), which has embedded one or more directives for decorating specified data in an indicated manner. Raw (e.g., undecorated) domain data for the page are received from a back-end store. A decoration engine parses the template, identifies the directives and applies them to generate decorated data in context. Directives may include metadata used by the decoration engine and/or a directives library. A render process is then applied to combine the template and the decorated data to produce the page's markup language (e.g., in HTML), which is transmitted to the client that requested the page.

### RELATED APPLICATION

This application claims priority to U.S. Provisional Patent Application No. 61/842,236, which was filed Jul. 2, 2013 and and is incorporated herein by reference.

### BACKGROUND

This invention relates to the fields of computers and data processing. More particularly, apparatus, system and methods are provided for enhancing a template for generating mark-up language, using directives in association with source data to affect the presentation of the data.

Generating HTML (HyperText Markup Language) or other markup language for a web page for presentation to a user can be time-consuming and/or resource-intensive. For example, separate development efforts are required to design each web page of a given web site by writing the necessary HTML code. Further, if different versions of a page are to be served to different users, additional effort is required not only to create the different versions, or to craft the program code for presenting different versions, but also to determine which to serve in response to a given request for the page.

Markup language development tools are sometimes used to ease the process of designing web pages. For example, a templating language allows a web developer to design a template that will generate the end markup language with an interface that may be more user-friendly than an editor for directly generating the markup language. Thus, the developer is able to craft markup language to serve his or her purpose without having to write the actual code.

Dust is one example of a language for creating a template for a web page or a portion of a web page. Dust provides a rich syntax that allows a designer to use basic program flow operations such as loops and conditionals, and includes or is accompanied by a javascript rendering library that compiles the template into javascript for easy rendering by a client application such as a browser.

However, these templates do not allow for dynamic formatting of data for presentation or for dynamic identification and insertion of presentation data at the time a page is to be rendered for a user. In particular, templates and templating languages generally do not provide the ability to specify how to generate or format presentation data.

One traditional method of ensuring proper presentation of data has involved creating all possible forms of presentation data, saving each form, and then retrieving and serving the specific version needed at the time the page is presented. However, this expands enormously the amount of data that a web server, data server or other origin server must maintain and manage, and is not an efficient solution. In addition, different templates would normally be required for each different set of data to be presented.

Another way to ensure proper presentation of data involves executing back-end code (e.g., program code operating on a data server) to retrieve specified data and convert and/or format the data for presentation. Illustratively, this may require a developer to generate and maintain custom code for treating links, formatters, i18n information (e.g., localized or internationalized strings) as special data elements to be identified and inserted at the back-end. However, this couples the data processing and presentation processing too tightly, requires continual updates to the code, and does not scale well in very busy environments. For example, in an environment (e.g., a web site) that serves data in many different formats or forms, if each version is coupled with separate custom code, changing a data format will require significant effort to update all the code.

Another possible solution to the need for customized presentation of data may involve porting all associated functionality (e.g., for localization, for formatting) to a client language such as javascript and downloading to the client platform for use by a browser or other application. However, customized data presentation may require hefty code libraries to enable all possible presentation operations, in which case significant downloads to the client would be required and would consume a great deal of bandwidth.

### DESCRIPTION OF THE FIGURES

FIG. 1 is a block diagram of a computing environment in which a decoration engine for generating presentation data at run-time may operate, in accordance with some embodiments of the invention.

FIG. 2 is a flow diagram illustrating creation of presentation data at the time and location it is to be presented, in accordance with some embodiments of the invention.

FIG. 3 is a flow chart demonstrating a method of decorating presentation data at the time a page of content is rendered, in accordance with some embodiments of the invention.

FIG. 4 identifies illustrative decoration directives, in accordance with some embodiments of the invention.

FIGS. 5-6 illustrate usage of a templating language to produce markup language.

FIG. 7 illustrates usage of a templating language with decoration directives to produce markup language for presenting decorated data, in accordance with some embodiments of the invention.

### DETAILED DESCRIPTION

The following description is presented to enable any person skilled in the art to make and use the invention. Various modifications to the disclosed embodiments will be readily apparent to those skilled in the art, and the general principles defined herein may be applied to other embodiments and applications without departing from the scope of the present invention. Thus, the present invention is not intended to be limited to the embodiments shown.

In some embodiments of the invention, a system and methods are provided for decorating template-produced markup language with presentation data. With these embodiments, different templates that use the same raw data can produce very different presentation data, without causing additional processing on a back-end server such as the data server where the original data is stored.

Some embodiments of the invention are described as they are implemented to modify the JavaScript-based templating language known as Dust, available at the URL corresponding to linkedin.github.io/dustjs/. In particular, these embodiments may function as extensions to the Dust templating language. In these embodiments, a Dust template is enhanced with directives such that when the template is combined with a JSON (JavaScript Object Notation) file and rendered to produce HTML (HyperText Markup Language), the data are decorated with the desired presentation or formatting, without requiring special processing on a back-end system (e.g., a data server) to select or produce the presentation data. In addition, only one native format of the data need be retained on the back-end, instead of storing multiple forms decorated differently.

Based on the following description, however, other embodiments of the invention may be configured and implemented with markup language or a markup language template created manually or with some other templating language, and may be combined with source data in any format to produce markup language having dynamically generated presentation data, without exceeding the scope of the invention.

As an illustrative scenario in which an embodiment of the invention may be implemented, consider a web page or a web page snippet in which a user's name is to be presented. If the page or page snippet is being presented in a traditional manner, such as via a web interface to a user's desktop or mobile computer, plenty of space is available and the name may be best presented in a full format, such as first name and last name. However, if the page or page snippet is being presented via a mobile interface, for display on a smart phone for example, less space is available and it may be better to shorten the name to first name and last initial. In either case, the same data is requested and served from the back-end (i.e., first name and last name), without require any difference in processing on the back-end, and the data is transformed as warranted or specified by a model view controller that implements the corresponding (Dust) template.

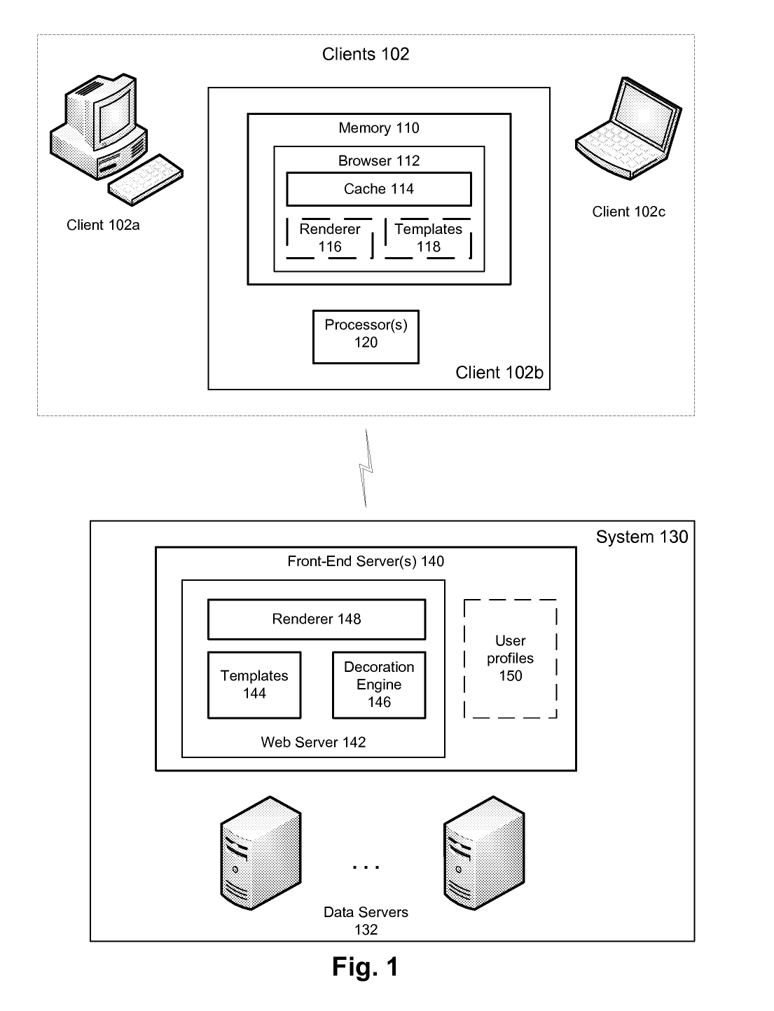

FIG. 1 is a block diagram of a computing environment in which a decoration engine for dynamically generating presentation data may operate, according to some embodiments of the invention.

In these embodiments, client devices 102 may include stationary and/or portable computing devices (e.g., desktop computers, laptop and notebook computers, tablet computers), as well as other portable devices such as smart phones and personal digital assistants. Users employ client devices, such as clients 102a, 102b, 102c to access system 130, which may host one or more web sites.

An illustrative client 102b includes traditional components that may include, but are not limited to, one or more processors, primary storage (e.g., memory) and secondary storage (e.g., a disk drive, a solid-state drive), a display component, input controls (e.g., keyboard, mouse), communication port(s) and so on. Not all components are depicted in FIG. 1. Client 102b loads an operating system and various programs into memory 110 at different times, for execution by processor(s) 120. Among the computer programs executed by client 102b is browser 112, which may be Firefox®, Internet Explorer®, Chrome® or a different browser application.

Browser 112 may have plug-ins or add-ons to enhance its operations, and includes cache 114 for storing data, web pages, markup language, markup language templates and/or other things. Cache 114 may include, or may instead be, a cache managed by an operating system of client 102b or some other application.

In some embodiments of the invention, dynamic decoration of data for presentation as described herein may involve processing on client 102b beyond display of the decorated data as part of a page of content. In these examples, page templates 118 for generating presentation markup language, a renderer 116 and/or other components involved in the dynamic decoration (or display of decorated data) may be stored and/or operate on client 102b (e.g., as part of browser 112).

System 130 includes one or more front-end server computers 140, each of which operates a web server application 142 (e.g., by Apache). Web server 142 stores templates and/or markup language 144 for generating markup language to present web pages and/or other content of the system, and decoration engine 146 for consuming markup language templates and/or other templates or markup language in order to identify and act upon embedded decoration directives. As discussed further below, a decoration directive may function to specify how to convert or format data for presentation by browser 110 to an operator of client 102b, using one or more decoration libraries.

Renderer 148 (or possibly renderer 116) receives as input a template and a set of data decorated by decoration engine 146, and outputs markup language for a web page (or a portion of a web page) for delivery to and presentation on a client 102. Decoration engine 146 and renderer 148 may be implemented as add-ons to web server 142, may operate as (or within) a library or proxy service, or may be implemented in some other way to operate with the web server application.

A front-end server 140 may also store user profiles 150, or portions of user profiles, which may be used to determine which web pages (or templates or markup language) to provide to a client, which data to serve with a web page, etc. Alternatively, user profiles may be stored elsewhere but be accessible to front-end server(s) 140.

System 130 also includes one or more back-end data servers 132 for storing data for serving to users/operators of clients 102. Illustratively, a user of client 102b connects to system 130 (e.g., via the Internet, via an intranet) to view content offered by the system. Based on the content (e.g., web page(s)) the user wishes to view, front-end server 140 processes corresponding templates, decorates associated data, renders the template and the decorated data, and serves the resulting markup language to browser 112 to process and display the content.

In some embodiments of the invention, system 130 is a professional network site (or professional social networking site) that operates to connect members of the site based on attributes such as their jobs, employers, careers, education, professional interests, skills and so on. The professional network may also assist members' job searches by helping them find employment opportunities and, conversely, assist employers' searches for new employees. The professional network may further assist individual and/or organizational members market products and services, find suppliers and/or purchasers, etc. In these embodiments, therefore, data stored by data server(s) 132 may include professional attributes of members such as those listed above, plus data reflecting interactions between members—such as comments, messages, discussions, endorsements, professional relationships, etc.

Advantageously, decoration and presentation of data at front-end server 140 for presentation on client 102b does not require additional processing on back-end data servers 132. In particular, servers 132 will serve domain data substantially in the same undecorated (raw) form in which it is stored, and decoration engine 146 of web server 142 will decorate it as specified by directives embedded in the markup language it processes when preparing a particular page of content (or portion of a page of content) for presentation.

Template directives prompt a decoration engine (e.g., decoration engine 146 of FIG. 1) to augment or transform associated source data in some way, and as described further below. Thus, when a request is received by a front-end server or web server, from a client browser, for a web page (or portion of a page) associated with a template, directives embedded in the template will be processed by the decoration engine. Alternatively, when a request for a set of source data is received (e.g., a hierarchical set of JSON data stored as x.data), a template associated with that data (e.g., x.tl) is retrieved and applied.

The template identifies each directive, which has a type, indicates the context in which the directive is declared, and may provide metadata information for assistance in processing the directive. Based on a directive's types, a corresponding directive library is called to obtain the data and transform/decorate it as specified, within the indicated context. Thus, a set of raw data (e.g., x.data) is decorated as directed, to produce a set of presentation data (e.g., x*.data).

Additionally, the decoration engine or some other component of system 130 will strip the directives from the template (e.g., x.tl), to produce a renderable template (e.g., x*.tl). A renderer (e.g., renderer 148, renderer 116) then operates to render the renderable template and the presentation data to produce HTML for display on the client. In some embodiments, the decoration engine of system 130 produces the presentation data and the renderable template, both of which are delivered to a client's browser, which then renders the HTML.

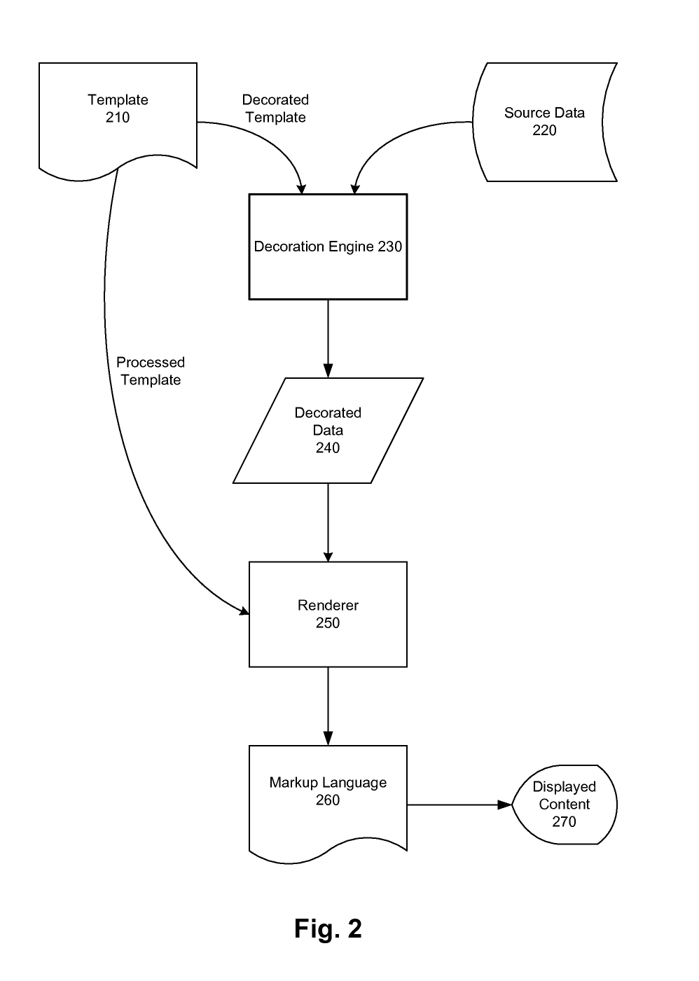

FIG. 2 is a flow diagram illustrating creation of content for presentation at the time it is to be presented, in accordance with some embodiments of the invention. In particular, in these embodiments, the presentation data is created at run-time or render time on the front-end server hosting a user's connection.

In embodiments of the invention reflected in FIG. 2, a markup language template 210 generated by Dust or some other templating language, and source data 220 in JSON (JavaScript Object Notation) format or some other format compatible with the template, are consumed by decoration engine 230. Source data may be received from or via a back-end server of a web site or system that maintains and uses the web page (or portion of a web page) based on template 210. In these embodiments, the source data has not been enhanced and is therefore in the same form or format in which it is served for use with other pages of content. In particular, the data has not been translated, formatted or other converted or decorated on the back-end origin server that stores and serves it.

The decoration engine reads or extracts directives specified in template 210 and applies them to source data 220 to produce decorated data 240. The directives are parsed and applied in context with the content of the template, to ensure the correct data are decorated, and that they are decorated correctly. For example, if a directive is defined within a loop (e.g., demarcated with “{#people}”), the directive is applied to all loop iterations. As one alternative, a directive may be configured to append the resulting presentation data to the root of the source data, rather than in the context or location where it is declared.

The decoration engine may have built-in functionality for applying the directives, or may resort to a library of program routines. In particular, decoration engine 230 may be implemented as an extension to Dust, and may draw upon a JavaScript library associated with Dust or with the web server with which the engine operates. Decorated data 240 thus includes source data 220 that has now been formatted or converted as specified by the author of template 210 for affecting the presentation of the data to a user.

Renderer 250 then consumes decorated data 240 and template 210 to render markup language 260 for presentation to a user of the client device as displayed content 270. Renderer 250 may be a function of a code library associated with decoration engine 230 and templating language used to create template 210, and/or the web server hosting the decoration engine. In particular, renderer 250 may be program code that is part of the Dust.js library. The decoration engine may be compatible with multiple types of templating languages (i.e., not just Dust), and the directives may therefore differ in form from one templating language to another (e.g., *i18n, $i18n, ##i18n).

In an operational environment in which a web site or other source serves web pages and/or other content to users, rendering of decorated data as described herein may involve more than one round-trip between a user's client computing device and a front-end server of the site.

For example, a client device requests a web page, web page snippet or other collection of content includes a set of source data and that is already associated with or mapped to a template (e.g., a Dust template). Illustratively, this request may be in the form of a call, embedded within HTML code for the page, to a javascript residing at the site and may specify a set of JSON data. The request is intercepted by a decoration engine (e.g., decoration engine 230 of FIG. 2) when received at the front-end server or after a back-end server responds to the request by supplying the requested source data. The decoration engine then applies the template's directives to decorate the data, and the decorated data is delivered to the client device.

In response to a follow-on request from the client for the template to use to render HTML on the client for presenting the decorated data, the server (e.g., possibly the decoration engine) responds with a processed or clean version of the template stripped of the decoration directives, which a renderer on the client device will be able to parse and apply.

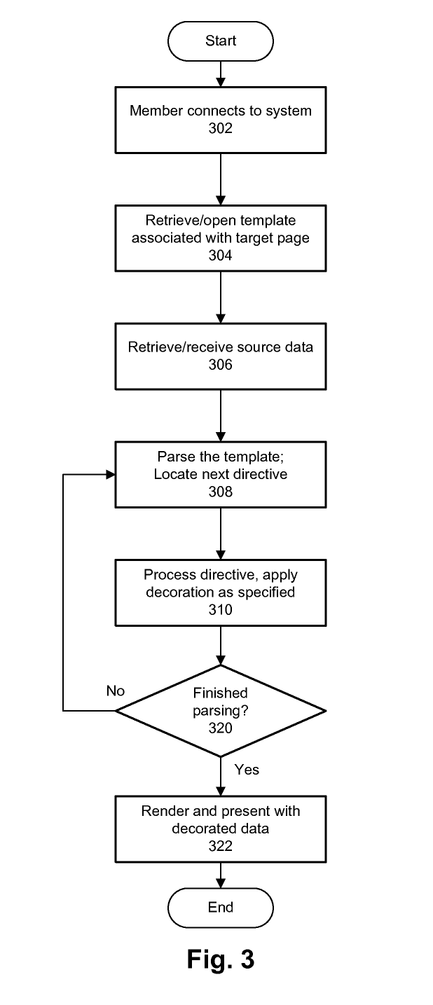

FIG. 3 is a flow chart demonstrating a method of decorating presentation data at the time a page of content is rendered, according to some embodiments of the invention. In these embodiments, the decoration or formatting of the data is primarily performed at a front-end server of a web site or other system or service for serving web-based content to users.

In operation 302, a member or user of an online service, such as a professional social network site, connects to a system that hosts the service by navigating her browser to a web page that is part of the service, such as a home page.

In operation 304, a template for generating markup language for displaying part or all of the web page is retrieved, based on the target page to be presented to the member. The template may encompass the entire page of content or only part of the page, in which case multiple templates may be retrieved and processed as described here.

In operation 306, data to be presented within the page is retrieved from a back-end store, such as a database management system or data server, without any decoration applied to prepare it for presentation. In the illustrated method, the template was constructed using the Dust templating language, and therefore the data is in JSON form. Both the template and the JSON data may be specified by the target page.

The JSON data may be retrieved based on an identity of the member. For example, when the member connected to the system, she logged in or otherwise verified her identity. The system then uses that identity to retrieve appropriate data from the data store, based on which page of content the member is navigating to.

The same set of back-end data may be retrieved in the same JSON format for use with multiple different templates, but as provided herein, the different templates will cause the data to be presented differently when processed by the decoration engine. In particular, the JSON data produced by the back-end store has not already been decorated, and thus may convey the domain data in a single form or format, rather than in multiple formats that have already been decorated. One set of source data may be mapped to and used by multiple different templates.

In operation 308, a decoration engine operating on the front-end server (e.g., as part of, or in associate with, a web server application) begins parsing the template and identifies the first or next directive. If the template contains no directives formatted for action by the decoration engine, the engine makes no change to the data or the resulting markup language.

In operation 310, the decoration engine processes a directive to decorate the specified data as indicated. The decoration may entail creating or retrieving localized data (e.g., to present a string of text in a local language), creating a URL (Uniform Resource Locator) to present within the page of content to allow the member to access associated information, retrieving a key value upon which additional conditional processing depends (e.g., for A/B testing), formatting data in a particular way, etc.

In operation 320, the decoration engine determines whether it has completed parsing the template and decorating the domain data. Until it finishes the template, it returns to operation 308 to locate and operate upon the next directive.

In operation 322, the template and the decorated data are rendered to produce markup language for presentation on the member's client device. The markup language (e.g., HyperText Markup Language or HTML) is conveyed to the client device's browser with the decorated data embedded within. After operation 322, the method ends, or is repeated for another template.

Thus, in an embodiment of the invention reflected in the flow chart of FIG. 3, data for presentation to a user are dynamically decorated (i.e., put into the desired presentation form or format) at render-time or run-time (i.e., when a page of content is being served to a user). This dynamic decoration occurs at the front-end of the system, and relieves back-end data stores from having to store multiple different presentation forms of data and having to serve more than one form (from which a traditional rendering process would select one desired form) and from having to apply extra processing to convert a native or raw form of the data into a desired presentation form.

Because the data stores may experience extremely high levels of activity in some computing environments, reducing the amount of processing they must perform and reducing the amount of data they must serve will allow them to provide greater throughput.

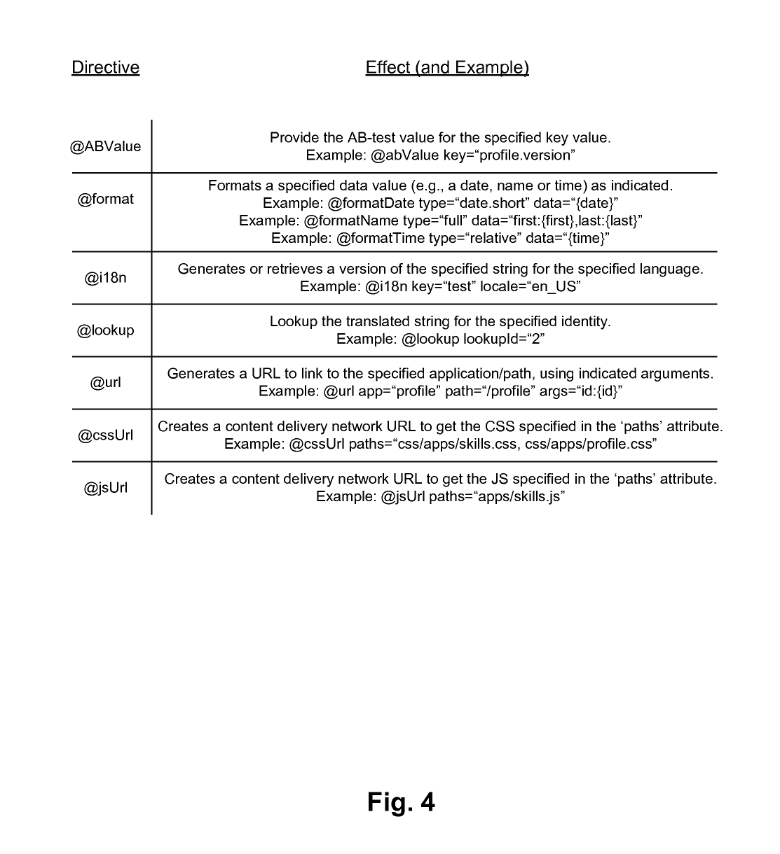

FIG. 4 identifies illustrative directives consumed by a decoration engine, according to some embodiments of the invention. The identified directives are merely illustrative, and different embodiments of the invention may implement subsets or supersets of these directives. As shown in FIG. 4, a directive may be accompanied by parameters that serve as keys or lookup values, as identifiers of applications, paths and/or other attributes, and may also include arguments.

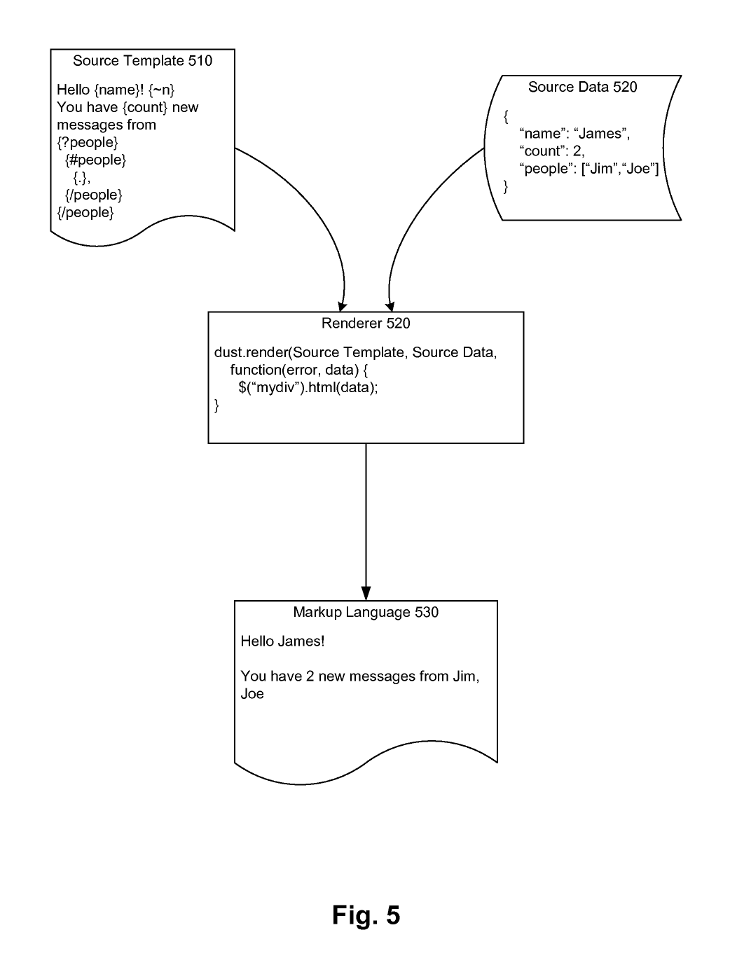

FIG. 5 illustrates usage of a templating language with source data, to produce renderable HTML. The illustrated template employs the Dust templating language, but other templating languages operate similarly.

In FIG. 5, source template 510 is a basic template that prints the name of a person and a count of message that person has received from other people. Source dataset 512 describes the person and the received messages. Template 510 and data 512 are consumed by javascript renderer 530, which may be included with the templating language or may be part of a code library that accompanies the templating language. Renderer 520 produces HTML 530, which may be executed by a browser or other client application to display the message.

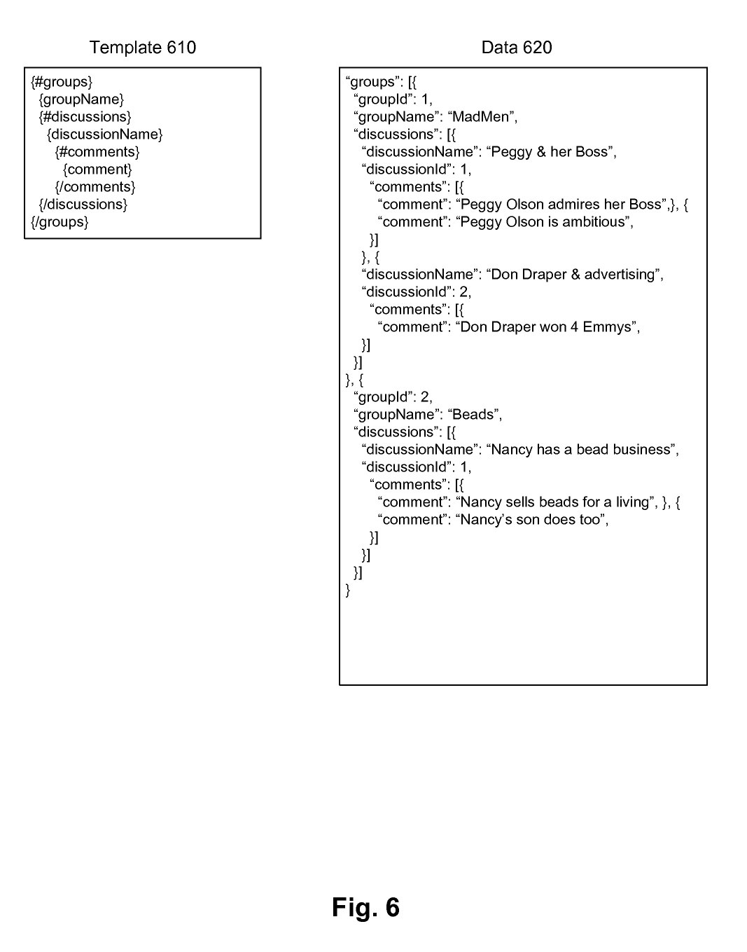

FIG. 6 provides another example of basic templating. This example demonstrates the use of a template with a hierarchical data structure as a JSON structure.

Template 610 is a portion of a template designed to present a set of groups a user belongs to; each group may have any number of discussion topics, and each discussion topic may have one or more comments. In this template, comments are nested within discussions, and discussions are nested within groups.

When this information is presented on a client, some formatting will be required, which may differ from formatting applied to the same data when presented on a different client. For example, different localization or internationalization may be applied. Therefore, template directives are enabled and may be embedded in the source template to perform the desired customization.

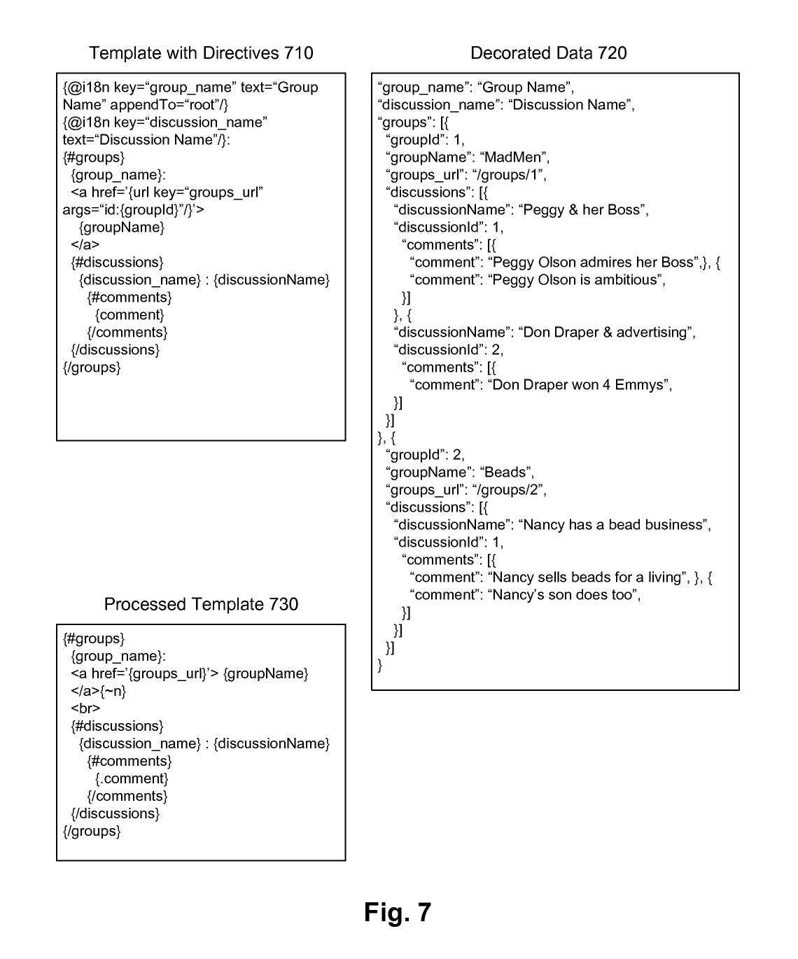

FIG. 7 depicts template 710, drawn from directive 610 of FIG. 6, but with decoration directives. A decoration engine reads template 710 and the associated source data (e.g., data 620), extracts and processes directives from the templates, and produces decorated data 720.

Processed template 730 is also produced by the decoration engine, stripped of decoration directives, and ready for use by a renderer. Thus, a renderer operating on the client or a front-end server (or elsewhere) can then render corresponding HTML or other markup language for presenting the data on the client.

As noted previously, directives may be embedded for operation in the desired context. For example, embedding a directive within a loop may cause desired values to be inserted during loop iterations. In contrast, use of the “appendTo” flag (as in template 710) serves to add the specified value to the top or root of the source data. A directive declared inside a conditional that evaluates to false may not be decorated. A directive declared inside a loop may result in all the elements of that loop data being decorated.

An environment in which some embodiments of the invention are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory, non-volatile memory, magnetic and optical storage devices such as disk drives, magnetic tape, CDs (compact discs) and DVDs (digital versatile discs or digital video discs), solid-state drives and/or other non-transitory computer-readable media now known or later developed.

Methods and processes described in the detailed description can be embodied as code and/or data, which can be stored in a non-transitory computer-readable storage medium as described above. When a processor or computer system reads and executes the code and manipulates the data stored on the medium, the processor or computer system performs the methods and processes embodied as code and data structures and stored within the medium.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. The scope of the invention is defined by the appended claims, not the preceding disclosure.

What is claimed is:

1. A method of decorating data for presentation, the method comprising:
receiving a request for a page of content;
retrieving a directive-enhanced template for generating markup language for the page;
receiving source data for the page;
parsing the template to identify one or more decoration directives; and
decorating the source data as indicated by the one or more decoration directives, to produce decorated data.

2. The method of claim 1, further comprising:
rendering the template and the decorated data to produce the markup language for the page; and
transmitting the markup language to a client device from which the request for the page of content was received.

3. The method of claim 2, further comprising:
generating a stripped version of the template without the one or more decoration directives;
wherein rendering the template comprises rendering the stripped version of the template.

4. The method of claim 1, further comprising:
generating a stripped version of the template without the one or more decoration directives; and
transmitting the stripped version of the template and the decorated data to a client device from which the request for the page of content was received;
wherein the client is configured to render the stripped version of the template to produce the markup language for the page.

5. The method of claim 1, wherein:
retrieving a template comprises retrieving a template generated using the Dust templating language; and
receiving source data comprises receiving the source data in JSON (JavaScript Object Notation) format.

6. The method of claim 1, wherein receiving source data comprises:
receiving the source data from a data server that stores only one form of the source data;
wherein the one form of the source data is served in response to all requests for the source data.

7. The method of claim 6, wherein the one form of the source data is undecorated.

8. The method of claim 1, wherein the method is performed at a web server.

9. The method of claim 1, wherein the source data are extracted from a data repository of a professional social networking site.

10. The method of claim 9, wherein the source data include one or more of:
an identity of a member of the professional social networking site;
one or more attributes of the member; and
identities of one or more professional associates of the member.

11. The method of claim 10, wherein the one or more attributes include at least one of:
a skill of the member; and
one or more endorsements of the skill.

12. A computer-readable medium storing instructions that, when executed by a processor, cause the processor to perform a method of decorating data for presentation, the method comprising:
receiving a request for a page of content;
retrieving a directive-enhanced template for generating markup language for the page;
receiving source data for the page;
parsing the template to identify one or more decoration directives; and
decorating the source data as indicated by the one or more decoration directives, to produce decorated data.

13. A system for decorating data for presentation, comprising:
one or more processors; and
memory configured to provide the one or more processors with instructions that, when executed, cause the one or more processors to:
receive a request for a page of content;
retrieve a directive-enhanced template for generating markup language for the page;
receive source data for the page;
parse the template to identify one or more decoration directives; and
decorate the source data as indicated by the one or more decoration directives, to produce decorated data.

14. The system of claim 13, wherein the memory is further configured to provide the one or more processors with instructions that, when executed, cause the one or more processors to:
render the template and the decorated data to produce the markup language for the page; and
transmit the markup language to a client device from which the request for the page of content was received.

15. The system of claim 13, wherein the memory is further configured to provide the one or more processors with instructions that, when executed, cause the one or more processors to:
generate a stripped version of the template without the one or more decoration directives;
wherein rendering the template comprises rendering the stripped version of the template.

16. The system of claim 13, wherein the memory is further configured to provide the one or more processors with instructions that, when executed, cause the one or more processors to:
generate a stripped version of the template without the one or more decoration directives; and
transmit the stripped version of the template and the decorated data to a client device from which the request for the page of content was received;
wherein the client is configured to render the stripped version of the template to produce the markup language for the page.

17. The system of claim 13, wherein receiving source data comprises:
receiving the source data from a data server that stores only one form of the source data;
wherein the one form of the source data is served in response to all requests for the source data.

18. The system of claim 13, further comprising:
a data server configured to store a single version of the source data;
wherein the single version of the source data is served to the memory without execution, on the data server, of any computer instructions for customizing the source data.
